(19) United States
(12) Patent Application Publication
(10) Pub. No.: US 2017/0308651 A1
(43) Pub. Date: Oct. 26, 2017

(54) PLATFORM AND METHODS OF DYNAMIC SCHEDULING FOR PERSONAL SERVICES

(71) Applicant: Dipesh Pattni, Mississauga (CA)

(72) Inventor: Dipesh Pattni, Mississauga (CA)

(21) Appl. No.: 15/493,156

(22) Filed: Apr. 21, 2017

Related U.S. Application Data
(60) Provisional application No. 62/326,681, filed on Apr. 22, 2016.

(51) Int. Cl. G06F 19/00; G06Q 40/08; G06Q 20/10

(52) U.S. Cl. CPC G06F 19/327; G06Q 20/10; G06Q 40/08

(57) ABSTRACT

Described is a system that provides an intermediary for health services. The system may include a client device, a service provider, and a financial intermediary. Accordingly, a user may submit a request to procure a personal care service from a list of available personal care services. The system may match the request with a service provider according to procurement information, and the user may receive confirmation of an approval to provide the requested personal care service. The system may also transfer funds from an account associated with the user to an account associated with the service provider.

### RELATED APPLICATIONS

This application claims the benefit of U.S. Provisional Patent Application No. 62/326,681 filed Apr. 22, 2016, the entirety of which is incorporated herein by reference.

### BACKGROUND

Current service providers such as home-care aides, typically utilize employment contracts to dispatch service providers and collect charges or payments. Such systems are not customized to customers that prefer to request services upon the customer's convenience. Furthermore, conventional approaches rely on the customer making payment on a recurring basis to an institution. Moreover, customers' guardians and power-of-attorneys are limited to service options available at the private firms or public firms whereas such options are limited in variety and not accessible to the vast number of customers. Accordingly, there is a need for an easier and more effective tool for procuring home care services.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 illustrates an example block diagram of an operating environment according to an embodiment of the disclosed subject matter.

FIG. 2 illustrates an example flow diagram of procuring a service from a service provider according to an embodiment of the disclosed subject matter.

FIG. 3 illustrates an example flow diagram of procuring a service from a service provider and transferring payment from an intermediary according to an embodiment of the disclosed subject matter.

FIG. 4 illustrates an example flow diagram of procuring a service from a service provider through a representative according to an embodiment of the disclosed subject matter.

FIG. 5 illustrates an example flow diagram of a server matching a customer with a service provider according to an embodiment of the disclosure.

FIG. 6 illustrates an example a flow diagram of a user selecting a service provider from a provided list according to an embodiment of the disclosure.

FIG. 7 illustrates an example block diagram of computing device according to an embodiment of the disclosure.

### DETAILED DESCRIPTION

### Example Operating Environment

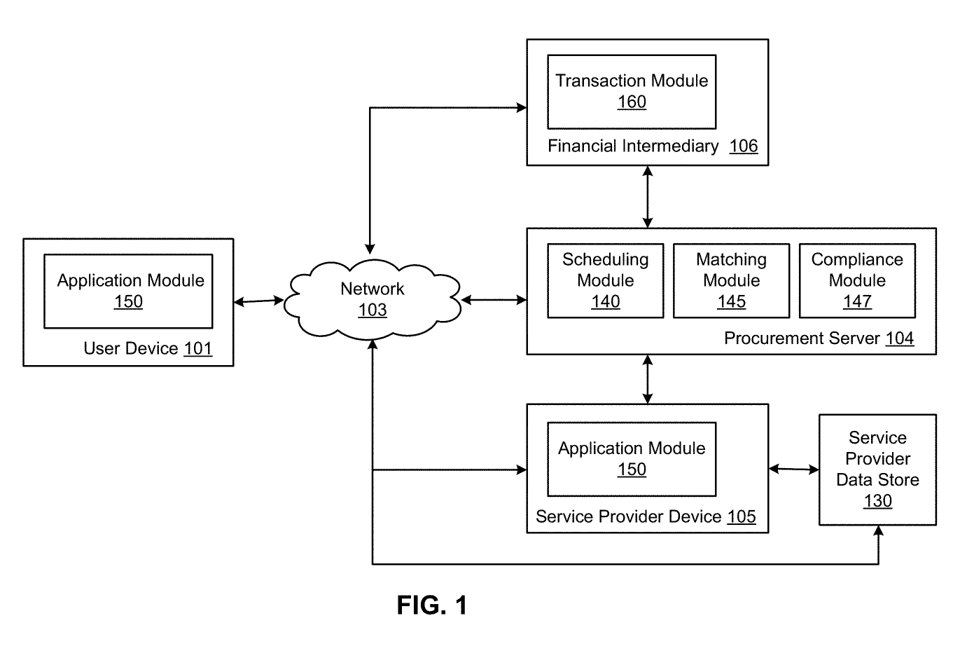

FIG. 1 is a block diagram illustrating an example operating environment according to an embodiment of the disclosure. In FIG. 1, system 100 may include a user device 101 (one or more) communicatively coupled to server 104 via a network 103. A service provider device 105, and a financial intermediary 106 may also be communicatively coupled to the network 103 and server 104. User device 101 (or client device) and service provider device 105 may be any type of computing device such as a personal computer (e.g. desktop, laptop, and tablet), a “thin” client, a personal digital assistant (PDA), a Web enabled appliance, a “Smartwatch,” or a mobile phone (e.g. Smartphone), etc. Network 103 may be any type of wired or wireless network such as a local area network (LAN), a wide area network (WAN) such as the Internet, or a combination thereof.

The user device 101 and the service provider device 105 may include an application module 150. The application module 150 may be installed directly on the device, or may be accessible through the network 103 from another device or a server. The application module 150 may act as the interface for requesting the service (e.g. from a user device 101), or an interface to accept or reject a requested service (e.g. from a service provider device 105).

Procurement server 104 (or server) may be any kind of server or a cluster of servers and may include a Web or cloud-based server, application server, backend server, or a combination thereof. Procurement server 104 may further include an interface (not shown) to allow devices (e.g. user device 101, or service provider device 105) to access resources or services provided by server 104. The interface may include a Web interface, an application programming interface (API), and/or a command line interface (CLI). The procurement server 104 may include scheduling module 140, a matching module 145, and a compliance module 147. The scheduling module 140 may process for example an on-demand service by determining when certain service providers are available. The matching module 145 may determine the type of service requested, and in response, provide a list of suitable service providers. The compliance module 147 may verify the procurement complies with various compliance structures. For example, the compliance module 147 may verify that the request (or procurement, or financial transaction) complies with a third-party service such as an insurance plan, which may be private or public. In another example, the compliance module 147 may verify the request complies with government procedures. For instance, the compliance module 147 may verify that the request complies with a government run health insurance plan.

Financial intermediary 106 may be a standalone device (e.g. server) as shown, or may be part of server 104, which as described above may be part of a cluster of servers. The financial intermediary 106 may process financial transactions between customers and service providers. For example, the financial intermediary 106 may include a transaction module 160 to process the transaction. For instance, the transaction module 160 may interface between financial accounts of the user and the service provider. A financial account or transaction may relate to, for example, online banking, online payment systems (e.g. PayPal), credit card transactions, money transfers, electronic wire transfers, and the like. The system may also include a service provider data store 130. The service provider data store 130 may include any relevant information related to procuring a personal care service. For example, the service provider store 130 may maintain a list of available service providers and the service that they offer.

With respect to the system configuration of FIG. 1, other architectures or configurations may also be applicable. For example, service provider store 130 may be maintained and hosted in a separate server as a content server over a network. Such a content server or additional servers may be organized and provided by the same provider or organization as of server 104. Alternatively, such a content server or additional servers may be maintained or hosted by separate providers or organizations (e.g., third-party providers), which are responsible for managing content in content databases.

The block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

### Example Interactions to Procure a Service

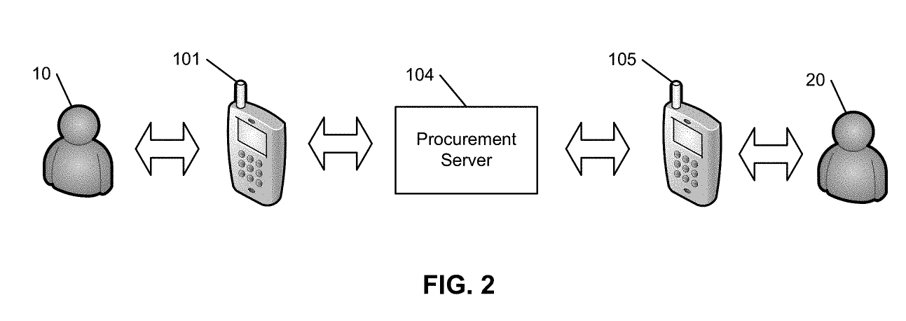

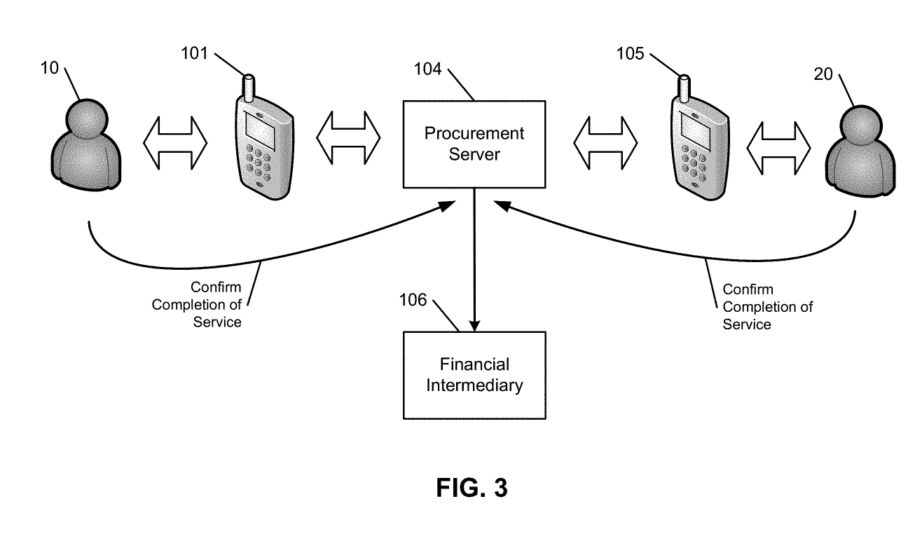

FIG. 2 illustrates an example flow diagram of procuring a service from a service provider according to an embodiment of the disclosed subject matter. As shown in FIG. 2, a user 10 may request a service (or personal care service) through a user device 101. For example, the user 10 may request a service from an application (e.g. instance of application module 150) on the user device 101, which is sent to the procurement server 104 for processing. The procurement server 104 may then process the request (e.g. match the request with a service provider and schedule the request), which is then relayed to a service provider device 105. An application on the service provider device 105 may then notify the service provider 20 (or personal care service provider) that a request has been received. As further described below, the service provider 20 may then reject or accept the service request. Once the service has been complete, a transfer of funds may occur as further described in FIG. 3. In addition to the user 10 requesting a service directly, in some embodiments, a guardian may request a service on behalf of the user 10. As referred to herein, a service provider 20 may include any person or entity that provides some form a service. For example, the service provider may include a care giver, home-care-aides, personal support workers, nurse practitioners, baby-sitters, nannies, pet-care providers, etc.

FIG. 3 illustrates an example flow diagram of procuring a service from a service provider and transferring payment from an intermediary according to an embodiment of the disclosed subject matter. FIG. 3 shows the procurement of a service as described in FIG. 2, and further shows the processing of a transfer of funds. For example, once a service has been completed by the service provider 20, the service provider 20 may confirm completion of service to the procurement server 104. Additionally, the user 10 may also confirm completion of service to the procurement server 104. Once the procurement server 104 receives confirmation from both parties, it may initiate a transfer of funds through a financial intermediary 106.

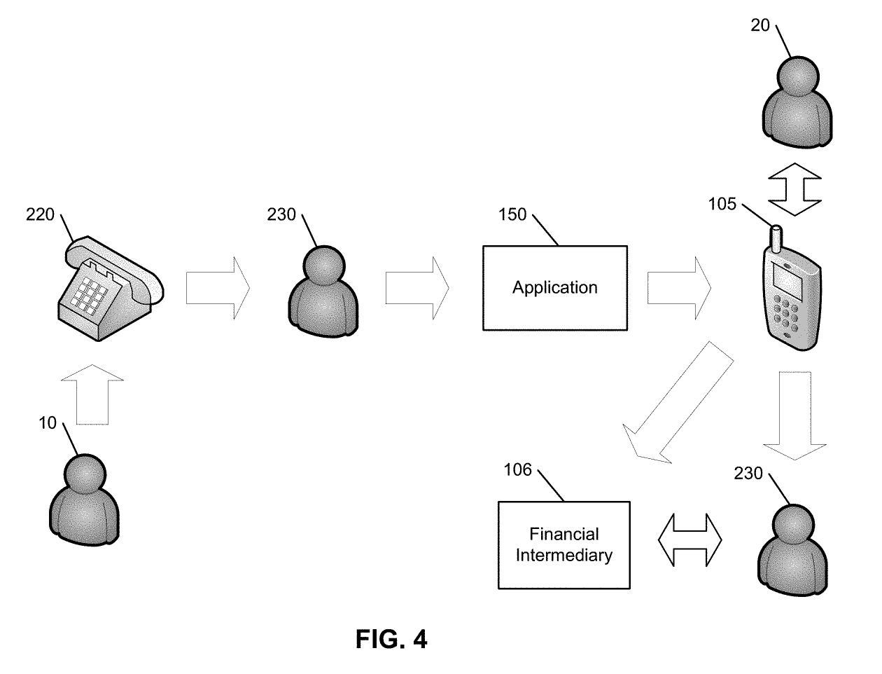

FIG. 4 illustrates an example flow diagram of an interaction between a customer, a representative, and a service provider according to an embodiment of the disclosed subject matter. In an embodiment, a representative 230 may facilitate the process of procuring a service. This allows users that may not potentially have direct access to the application (e.g. elderly persons) to still be able to request a service. As shown in FIG. 4, a user 10 may use a telephone 220 to place a call to a representative 230. The representative 230 may receive the pertinent information (e.g. type of service requested and a time) from the user 10 and enter it into the application 150 (e.g. instance of application 150 on a representative device). The application 150 may then relay the information to the service provider device 105. The service provider 20 may then accept or reject the request. When a service is accepted and once the service request has been completed, the service provider 20 may indicates that the service was completed. The service provider device 105 may then provide an indication of a completion of service and a transfer of funds may occur through a financial intermediary 106. In addition, the service provider device 105 may also provide an indication of a completion of service to the representative 230. The representative 230 may verify the completion of service and authorize the transfer of funds via a financial intermediary 106 from an account associated with the user 10, to an account associated with the service provider 20. It should be noted that although the financial intermediary 106 is shown as a separate component, it may be part of the procurement sever 104.

### Example Service Procurement Scenarios

In a first example, a user (e.g. user 10) may procure a personal care service from their personal device (e.g. user device 101). For example, a user may procure the personal care service from an application running on a personal tablet or smartphone. In order to procure a personal care service, the user may open an application (e.g. application 150) and select an option on the application screen to request service (e.g. a “Care Request” selection). This selection may provide a set of choices for the type of care needed. The choices may fall into various categories including, for example, health care, senior care, child care, and pet care. Healthcare choices may include, for example, a) dentist; b) physical therapy; c) occupational therapy; d) massage therapy; e) optometrist and ophthalmology; and other suitable categories. Senior care choices may include a) home errands; b) reading buddy; c) shopping and errands; d) physical therapist; e) occupational therapist; f) nurse; and any other suitable categories. Child care choices may include, for example, a) babysitter b) chaperone and social nanny; c) nanny care; and other suitable choices. Pet care choices may include, for example, a) walker; and b) grooming; c) veterinary appointment.

Once the category type is selected, the user may have the option to select a specific service provider (e.g. service provider 20) from a list of providers. The list may be based on a preferences profile including information such as location, languages spoken, specialties, or any other pertinent information that may aid the user in selecting an appropriate service provider. In some embodiments, the service provider may also be associated with recommendations, reviews, or other related information. Each listing of a caregiver may also include background information about the service provider such as education, specialties, or other information. Upon making the selection of a service provider, the user can request the service “On-Demand” or “On-Schedule” for a later date and time. For example, an “On-Demand” service may include a service that is requested as soon as possible, and an “On-Schedule” service may include a service schedule at a particular time. The application will submit the request to the procurement server, which relays the request to the selected service provider's device.

Once the server relays the request information, the service provider will receive a notification or alert on their device (e.g. service provider device 105). For example, the service provider may receive the notification on their personal tablet or smartphone device. The notification will notify the service provider of the request and include any pertinent information. For example, the request may include information regarding the patient, type of service, location, and a requested time widow to fulfil the request. In response, the service provider can choose to accept or reject the service. As described above, the work order that may be an immediate request or a scheduled service request.

When the request is accepted, the service provider arrives at the user's location to provide the requested personal care service. Upon completion of the service, the service provider may provide an indication on the application running on their personal device that the service is complete. The application may then transmit a notification of a completion of service to the procurement server, which relays to notification to the user's device (e.g. tablet or smart phone). The user may then confirm that the service is complete by indicating such on the application, and in turn, the service provider receives confirmation from the transaction on the service provider's personal device. Funds may then be transferred from the user's account to the service provider's account. For example, the financial intermediary 106 may perform the transaction. In some embodiments, a fee is collected for the transaction and the balance settled into the service provider's account.

In a second example, a guardian may request a personal care service on behalf of the person requiring the service. As described above, a guardian may request a service via from application running on a tablet or smartphone. The guardian selects the option on the screen for a service request. This selection provides additional choice of the type of service requested. Once the category type is selected, the guardian has the option to select the specific service provider from a list, which may include a profile details about the service provider. Upon making the selection of the service provider, the guardian can request the service “On-Demand” or “On-Schedule.” The application will submit the request to the procurement server which relays this request to the service provider.

The service provider will receive an alert on a tablet or smartphone of the need for their service. The service provider can choose to accept or reject the request. When a service request is accepted, the service provider arrives at the user's location to provide the service. Upon completion of the service requested, the service provider confirms completion of the service to the procurement server which relays the notification to the guardian's device (e.g. tablet or smart phone). The guardian may then accept that confirmation of the service has been completed. In order to confirm the service was completed, the guardian may call the user to verify whether the service was completed. Once the guardian accepts the completion of the service, the service provider receives confirmation from the transaction. Funds may then be transferred from the guardian's account to the service provider's account. A fee may also be collected for this transaction and the balance settled into the service provider's account.

In a third example, a user contacts a representative (or agent, or call center operator) to facilitate the process of procuring a personal care service. For example, a user may use call a telephone number designated for care services. The user specifies the type of service, and the date and the time of when the personal care service is required. A representative on the phone may then enter the applicable information into the application. The representative selects the option on the screen for the service request. This selection may provide additional choices of the type of service needed. Once the category type is selected, the representative has the option to select the specific service provider from a list of providers including, as described above, profile details about the service provider. The representative reads off the choices to the user, and the user may select the preferred service provider. Upon making the selection of the service provider, the representative can request the service “On-Demand” or “On-Schedule” according to the user's needs. The application will submit the request to the server which relays this request to the service provider. As described above, the service provider will receive an alert on a device of the need for their service, and the service provider can choose to accept or reject the service request. When accepted, the service provider arrives at the user's location to provide the service. Upon completion of the service requested, the service provider confirms the service is complete and the procurement server relays the request to the representative. The representative calls the user to confirm the service was completed. Once the user confirms the completion of the service, the service provider receives confirmation of the transaction. Funds may then be transferred from the user's account to the service provider's account. A fee may also be collected for this transaction and the balance settled into the service provider's account.

### Example Processes for Procuring a Personal Care Service

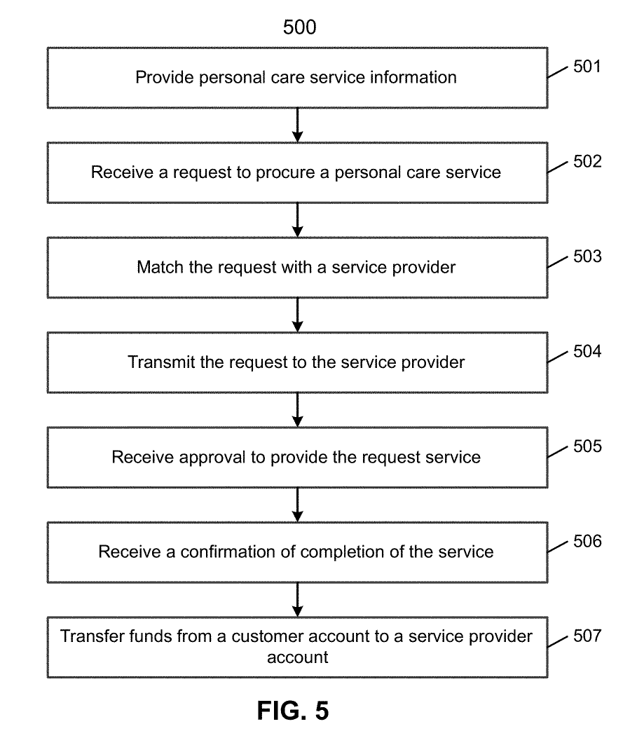

FIG. 5 shows a flow diagram of a server matching a customer with a service provider according to an embodiment of the disclosure. Process 500 may use processing logic which may include software, hardware, or a combination thereof. For example, process 600 (or method) may be performed by a computing device or device (e.g. procurement server 104). In 501, the device may provide, to a first client device associated with a user (e.g. user device 101), available personal care service information. In 502, the device may receive, from the first client, a request to procure a personal care service for the user from the available personal care service information. In an embodiment, the request includes procurement information specifying at least a type of personal care service and an appointment time. For example, the appointment time include one of an on-demand service or an on-schedule service.

In 503, the device may match the request with a service provider according to the procurement information. In 504, the device may transmit, to a second device associated with the service provider (e.g. server provider device 105), the request to procure the personal care service. In an embodiment, the matching includes determining a location of the user based on location information associated with the first client device, determining a location of the service provider based on location information associated with the second client device, and selecting the service provider based on a proximity of the location of the service provider to the location of the user. For example, the location information associated with the first client device and the location information associated with the second client device may include GPS coordinate information.

In 505, the device may receive, from the second client device, an approval to provide the requested personal care service, and the device may transmit, to the first client device, the approval to provide the requested personal care service. Accordingly, in 506 the device receives, from the first client device and the second client device, a confirmation of completion of the requested personal care service. Finally, in 507 the device may initiate a transfer funds from an account associated with the user to an account associated with the service provider. In embodiments, the user may include a guardian of the user. In another embodiment, user may include a representative or call center operator that receives the procurement information from the user.

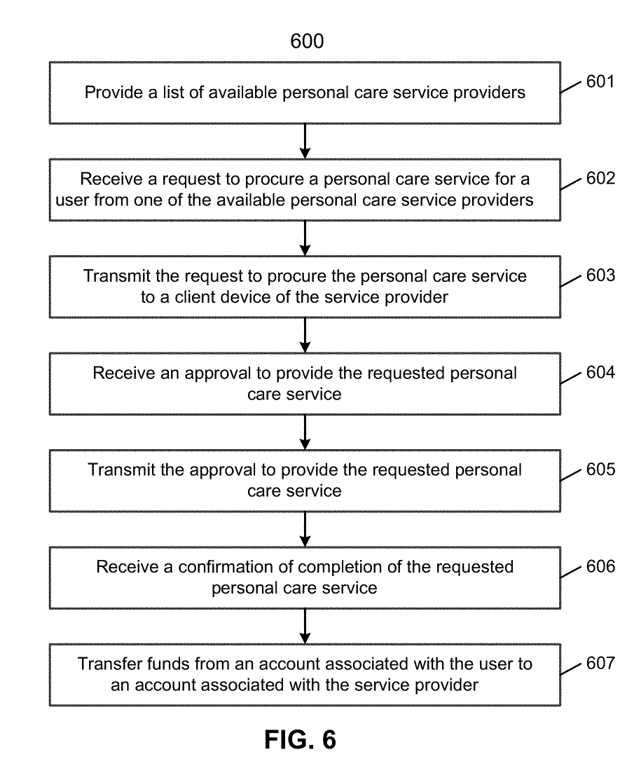

FIG. 6 shows a flow diagram of a user selecting a service provider from a provided list according to an embodiment of the disclosure. Process 600 may use processing logic which may include software, hardware, or a combination thereof. For example, process 600 (or method) may be performed by a computing device or device (e.g. procurement server 104). In 601, the device may provide, to a first client device (e.g. user device 101) associated with a user, a list of available personal care service providers. In an embodiment, the device may provide the list of available personal care service providers includes determining a location of the user based on location information associated with the first client device, determining a location of a set of service providers based on location information associated with the second client device, and selecting the list of available personal care service providers based on a proximity of the location of the set of service providers to the location of the user.

In 602, the device may receive, from the first client, a request to procure a personal care service for a user from one of the available personal care service providers. In an embodiment, the request includes procurement information. In addition, the request may include specifying at least a type of personal care service and an appointment time.

In 603, the device may transmit, to a second client device associated with the service provider (e.g. server provider device 105), the request to procure the personal care service. In 604, the device may receive, from the second client device, an approval to provide the requested personal care service. In 605, the device may transmit, to the first client device, the approval to provide the requested personal care service. In 606, the device may receive, from the first client device and the second client device, a confirmation of completion of the requested personal care service. Accordingly, in 607 the device may transfer, in response to receiving the confirmation of completion of the requested personal care service, funds from an account associated with the user to an account associated with the service provider.

### Example Computing Device

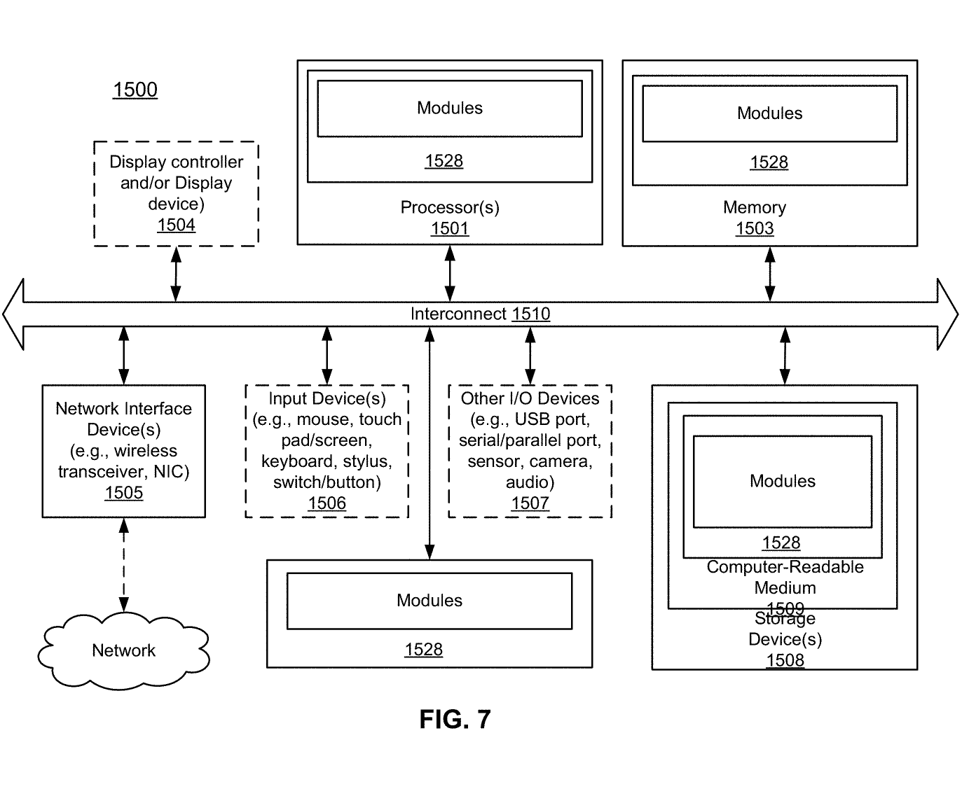

FIG. 7 is a block diagram illustrating an example computing system according to an embodiment of the disclosure. For example, system 1500 (or computer, computing device, or device) may represent any of systems or computing devices described above performing any of the processes or methods described above, such as, for example, server 104, user device 101, service provider device 105, or financial intermediary 106 described above.

System 1500 can include many different components. In one embodiment, system 1500 includes processor 1501, memory 1503, and devices 1505-1508 via a bus or an interconnect 1510. Processor 1501 may represent a single processor or multiple processors with a single processor core or multiple processor cores included therein. Processor 1501 may represent one or more general-purpose processors such as a microprocessor, a central processing unit (CPU), or the like. Processor 1501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1501 may be configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment may be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices.

System 1500 may further include IO devices such as devices 1505-1508, including network interface device(s) 1505, optional input device(s) 1506, and other optional 10 device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

Storage device 1508 may include computer-accessible storage medium 1509 (also known as a machine-readable storage medium or a computer-readable medium) on which is stored one or more sets of instructions or software (e.g., module, unit, and/or logic 1528) embodying any one or more of the methodologies or functions described herein.

Module/unit/logic 1528 may represent any of the components described above, such as, for example, application module 150, scheduling module 140, the matching module 145, and transaction module 160. Module/unit/logic 1528 may also reside, completely or at least partially, within memory 1503 or within processor 1501 during execution thereof by system 1500. In addition, module/unit/logic 1528 can be implemented as firmware or functional circuitry within hardware devices. Further, module/unit/logic 1528 can be implemented in any combination hardware devices and software components.

Embodiments may also be embodied in the form of a computer-readable storage (or medium) containing instructions embodied in non-transitory or tangible memory or storage, wherein, when the instructions are loaded into and executed by a computing device (or processor, e.g. processor 1501), the computing device becomes an apparatus for practicing implementations of the disclosed subject matter.

Components such as a processor may be described herein as “configured to” perform various operations. In such contexts, “configured to” includes a broad recitation of structure generally meaning “having circuitry that” performs functions during operation. As such, the component can be configured to perform such functions even when the component is not currently on.

Reference in the specification to “one embodiment” or “an embodiment” means that a particular feature, structure, or characteristic described in conjunction with the embodiment can be included in at least one embodiment of the disclosure. The appearances of the phrase “embodiment” in various places in the specification do not necessarily all refer to the same embodiment.

In the foregoing specification, embodiments of the disclosure have been described with reference to specific embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

Various implementations may include or be embodied in the form of computer-implemented process and an apparatus for practicing that process. Implementations may also be embodied in the form of a computer-readable storage containing instructions embodied in a non-transitory and tangible storage and/or memory, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the embodiments described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the embodiments described herein. For instance, components may be added, omitted, and may interact in various ways known to an ordinary person skilled in the art.

References to “one embodiment,” “an embodiment,” “an example embodiment,” and the like, indicate that the embodiment described may include a particular feature, but every implementation may not necessarily include the feature. Moreover, such phrases are not necessarily referring to the same embodiment. Further, when a particular feature is described in connection with an embodiment, such feature may be included in other embodiments whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method of providing personal care service, comprising:
providing, by a server and to a first client device associated with a user, available personal care service information;
receiving, at the server and from the first client device, a request to procure a personal care service for the user from the available personal care service information, wherein the request includes procurement information specifying at least a type of personal care service and an appointment time;
matching, by the server, the request with a service provider according to the procurement information;
transmitting, to a second client device associated with the service provider, the request to procure the personal care service;
receiving, from the second client device, an approval to provide the requested personal care service;
transmitting, to the first client device, the approval to provide the requested personal care service;
receiving, from the first client device and the second client device, a confirmation of completion of the requested personal care service; and
transferring, in response to receiving the confirmation of completion of the requested personal care service, funds from an account associated with the user to an account associated with the service provider.

2. The method of claim 1, wherein the matching the request with the service provider comprises:
determining a location of the user based on location information associated with the first client device;
determining a location of the service provider based on location information associated with the second client device; and
selecting the service provider based on a proximity of the location of the service provider to the location of the user.

3. The method of claim 2, wherein the location information associated with the first client device and the location information associated with the second client device comprises GPS coordinate information of the first client device and the second client device respectively.

4. The method of claim 1, wherein the appointment time comprises one of an on-demand service or an on-schedule service.

5. The method of claim 1, wherein the user is a guardian of the user.

6. The method of claim 1, wherein the user is a representative that receives the procurement information from the user.

7. A method of providing personal care service, comprising:
providing, by a server to a first client device associated with a user, a list of available personal care service providers;
receiving, at the server and from the first client device, a request to procure a personal care service for a user from one of the available personal care service providers, wherein the request includes procurement information;
transmitting, to a second client device associated with the service provider requested, the request to procure the personal care service;
receiving, from the second client device, an approval to provide the requested personal care service;
transmitting, to the first client device, the approval to provide the requested personal care service;
receiving, from the first client device and the second client device, a confirmation of completion of the requested personal care service; and
transferring, in response to receiving the confirmation of completion of the requested personal care service, funds from an account associated with the user to an account associated with the service provider.

8. The method of claim 7, wherein providing the list of available personal care service providers comprises:
determining a location of the user based on location information associated with the first client device;
determining a location of a set of service providers based on location information associated with the second client device; and
selecting the list of available personal care service providers based on a proximity of the location of the set of service providers to the location of the user.

9. The method of claim 7, wherein the request comprises specifying at least a type of personal care service and an appointment time.

10. The method of claim 9, wherein the appointment time comprises one of an on-demand service or an on-schedule service.

11. A method of providing personal care service, comprising:
transmitting, by a server to a first client device associated with a user, available personal care service information;
receiving, at the server and from the first client, a request to procure a personal care service for a user from the available personal care service information, wherein the request includes procurement information specifying at least a type of personal care service and an appointment time;
verifying, by the server, the request complies with a third-party service;
matching, by the server, the request with a service provider according to the procurement information;
transmitting, to a second client device associated with the service provider, the request to procure the personal care service;
receiving, from the second client device, an approval to provide the requested personal care service;
transmitting, to the first client device, the approval to provide the requested personal care service;
receiving, from the first client device and the second client device, a confirmation of completion of the requested personal care service; and
transferring, in response to receiving the confirmation of completion of the requested personal care service, funds from an account associated with the user to an account associated with the service provider.

12. The method of claim 11, wherein verifying the request complies with the third-party service comprises verifying the request complies with a government insurance plan.

13. The method of claim 11, wherein verifying the request complies with the third-party service comprises verifying the request complies with a private insurance plan.
